(19) United States
(12) Patent Application Publication
(10) Pub. No.: US 2013/0265313 A1
(43) Pub. Date: Oct. 10, 2013

(54) MEASUREMENT DEVICE AND METHOD OF GRAPHIC PROCESSING FOR MEASURING ELEMENTS OF OBJECTS

(71) Applicants: HONG FU JIN PRECISION INDUSTRY (ShenZhen) CO., LTD., (US); HON HAI PRECISION INDUSTRY CO., LTD., New Taipei (TW)

(72) Inventors: CHIH-KUANG CHANG, New Taipei (TW); XIN-YUAN WU, Shenzhen (CN); ZHENG-ZHI ZHANG, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 13/855,701

(22) Filed: Apr. 2, 2013

(30) Foreign Application Priority Data
Apr. 9, 2012 (CN) 201210101927.5

(51) Int. Cl. G06T 11/20

(52) U.S. Cl. CPC G06T 11/206
USPC 345/440

(57) ABSTRACT

In a measurement device and a method of graphic processing for measuring elements of an object, original measuring points which are sampled on the object are acquired, a measuring element is fitted using the original measuring points. Vectors of the original measuring points are computed based on the measuring element, and the measuring element and the original measuring points are drawn based on the vectors. New measuring points are generated according to a number of the original measuring points, and corrected coordinates of the new measuring points are computed according to a predetermined deviation. The new measuring points are drawn on the measuring element according to the corrected coordinates, and the original measuring points are deleted from the measuring element. A measuring sequence of the new measuring points is determined to generate a measuring program.

### BACKGROUND

1. Technical Field

Embodiments of the present disclosure relate to three-dimensional measurement system and method, and more particularly to a measurement device and method of graphic processing for measuring elements of objects under measured.

2. Description of Related Art

In an original three-dimensional (3D) measurement system and method, measuring points on an object are sampled by users using a probe of a 3D measurement equipment. The measuring points sampled by the users may have some mistakes, thus measuring elements, such as lines, planes, circles, and so on, fitted according to the measuring points may be inaccurate. In addition, such system and method need the users to sample the measuring points on the object one by one, thus, sampling efficiency is low.

### BRIEF DESCRIPTION OF THE DRAWINGS

FIG. 1 is a block diagram of one embodiment of a measurement device including a graphic processing system.

FIG. 2 is a block diagram of one embodiment of function modules of the graphic processing system in FIG. 1.

FIG. 3 illustrates a flowchart of one embodiment of a method of graphic processing for measuring elements of an object using the measurement device of FIG. 1.

FIG. 4 is schematic diagram of a parameters adjusting window.

FIG. 5 is an example illustrating how to generate new measuring points.

### DETAILED DESCRIPTION

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable storage medium or other storage device. Some non-limiting examples of non-transitory computer-readable storage medium include CDs, DVDs, BLU-RAY, flash memory, and hard disk drives.

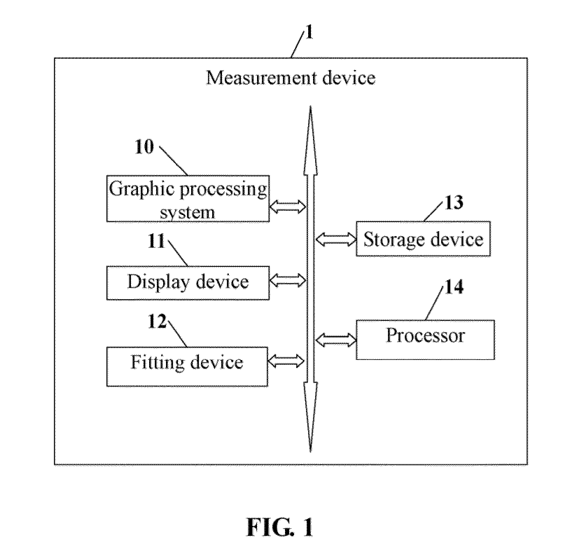

FIG. 1 is a block diagram of one embodiment of a measurement device 1 including a graphic processing system 10. The measurement device 1 may be, for example, a computer, a server, and so on.

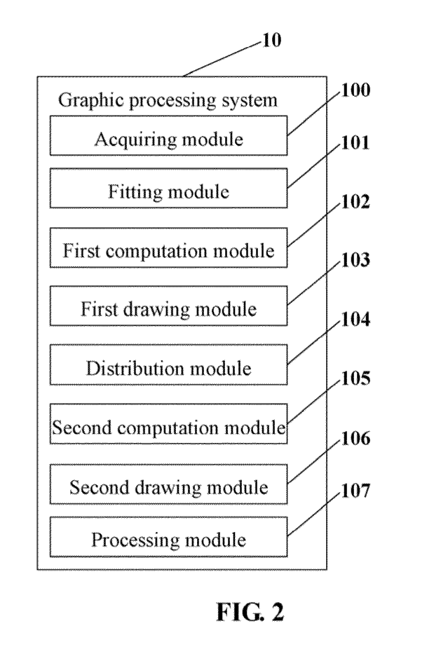

The graphic processing system 10 includes a plurality of function modules (see FIG. 2), which include computerized codes when executed to provide a method of graphic processing for measuring elements on an object (not shown). The measuring elements may include types, such as, points, lines, planes, circles, cylinders, spheres, and so on. In one embodiment, the graphic processing includes, such as, fitting the measuring elements according to measuring points sampled on the object by a user using a probe of a 3D measurement equipment (not shown), computing vectors of the measuring points based on the fitted measuring elements, drawing the measuring elements based on the vectors, adjusting the measuring points on the measuring elements, and generating a measuring program according to the adjusted measuring points.

The measurement device 1 further includes a display device 11, a fitting device 12, a storage device 13, and a processor 14. The display device 11 is used to display visible data of the measurement device 1. The fitting device 12 is used to fit the measuring elements using the measuring points. In the present application, the measurement device 12 fits each type of the measuring elements using the measuring points, computing a fitting deviation of each type of the measuring elements, and outputting basic information and the fitting deviations of the measuring elements. For example, the user samples four measuring points on the object using the probe, then, the fitting device 12 fits a line, a plane, a circle, a cylinder, and a sphere using the four measuring points, and further computing a fitting deviation of each of the line, the plane, the circle, the cylinders, and the sphere. In one embodiment, the fitting device 12 fits the measuring elements using Newton iteration method.

If the measuring element is a line, the basic information includes coordinates of a starting point, an ending point, and a vector of the line. If the measuring element is a circle, the basic information includes coordinates of the center, radius, and a vector of the circle. If the measuring element is a plane, the basic information includes coordinates of the center and a vector of the plane. If the measuring element is a cylinder, the basic information includes coordinates of the center, radius, a height, and a vector of the cylinder. If the measuring element is a sphere, the basic information includes coordinates of the center, radius, and a vector of the sphere.

The storage device 13 may include any type(s) of non-transitory computer-readable storage medium, such as a hard disk drive, a compact disc, a digital video disc, or a tape drive . The storage device 13 stores the computerized codes of the function modules of the graphic processing system 10. The processor 14 may execute the computerized codes of the function modules of the graphic processing system 10 to realize functions of the graphic processing system 10.

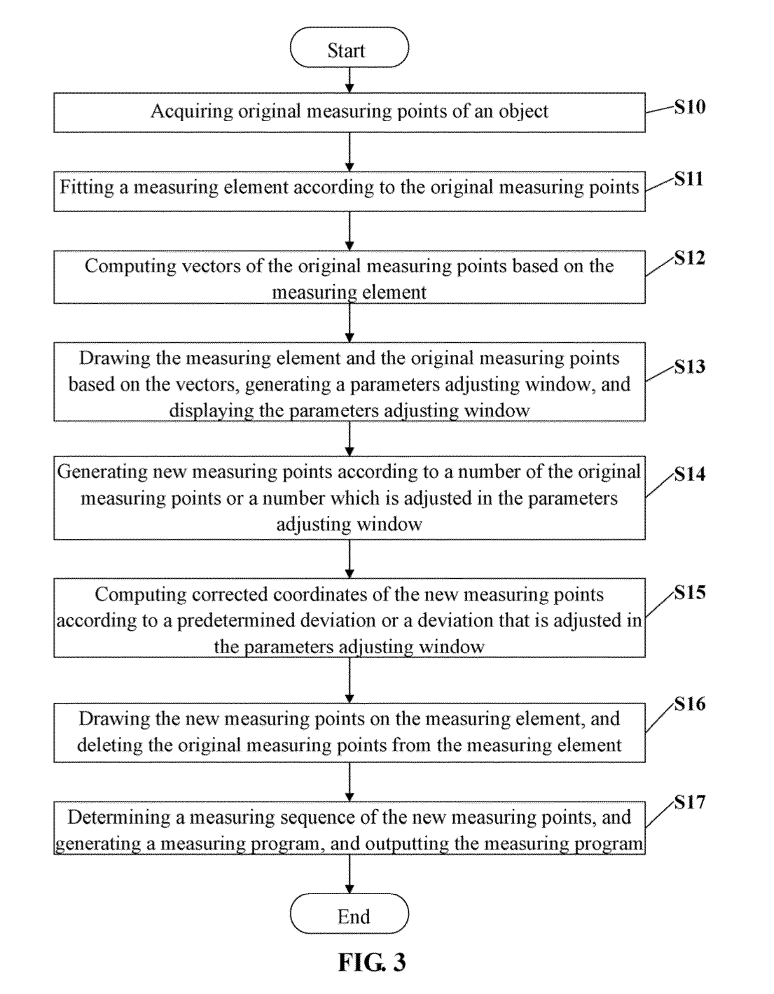

FIG. 2 is a block diagram of one embodiment of the function modules of the graphic processing system 10. In one embodiment, the function modules may include a an acquiring module 100, a fitting module 101, a first computation module 102, a first drawing module 103, a distribution module 104, a second computation module 105, a second drawing module 106, and a processing module 107. The functions of the function modules 100-107 are illustrated in FIG. 3 and described below.

FIG. 3 illustrates a flowchart of one embodiment of a method of graphic processing for measuring elements of an object using the measurement device 1 of FIG. 1. Depending on the embodiment, additional steps may be added, others removed, and the ordering of the steps may be changed.

In step S10, the acquiring module 100 acquires original measuring points which are selected on the object under measured using a probe of a 3D measurement equipment by a user.

In step S11, the fitting module 101 transmits coordinates of the original measuring points to the fitting device 12 to obtain a fitted measuring element and basic information of the fitted measuring element from the fitting device 12. As mentioned above, the fitting device 12 fits each type of the measuring elements using the original measuring points, and computes a fitting deviation of each of the measuring elements. The fitting module 101 obtains the fitted measuring element which has the least fitting deviation from the measuring elements.

In step S12, the first computation module 102 computes vectors of the original measuring points based on the fitted measuring element. In one embodiment, if the fitted measuring element is a line, the vectors are vertical to the line; if the fitted measuring element is a circle, the vectors are pointed to the center of the circle; if the fitted measuring element is a plane, the vectors are vertical to the plane; if the fitted measuring element is a cylinder, the vectors are vertical to the center axis of the cylinder; and if the fitted measuring element is a sphere, the vectors are pointed to the center of the sphere. For example, if the fitted measuring element is a circle, the coordinates of the center of the circle is (x0, y0, z0), a radius of the circle is R1,and the coordinates of the original measuring point is (x1, y1, z1), then the vector (I, J, K) of the original measuring point is I=(x0−x1)/R, J=(y0−y1)/R, K=(y0−y1)/R.

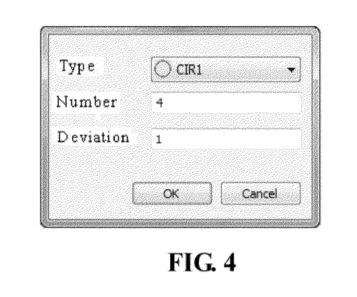

In step S13, the first drawing module 103 draws the fitted measuring element and the original measuring points based on the vectors of the original measuring points, generates a parameter adjusting window, and displays the parameter adjusting window on the display device 11. The parameter adjusting window can be used to adjust a number of measuring points and a deviation of each of the measuring elements. A schematic diagram of the parameter adjust window is shown in FIG. 4. The parameter adjust window includes a type box for selecting a measuring element, a number box for adjusting a number of the measuring points of the selected measuring element, and a deviation box for adjusting a deviation of the measuring element. In one embodiment, the deviation is determined according to a radius of a head part of the probe of the 3D measurement equipment. The head part of the probe may be a sphere or a ball.

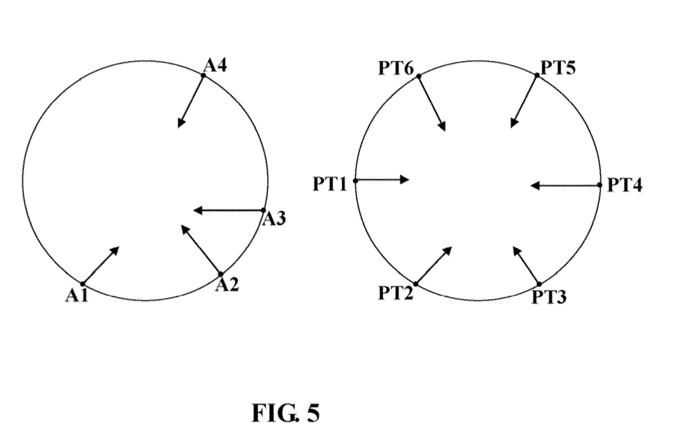

In step S14, the distribution module 104 generates new measuring points according to a number of the original measuring points or a number which is adjusted using the parameters adjusting window. In one embodiment, the new measuring points are distributed equally on the fitted measuring element. FIG. 5 shows that the fitted measuring element is a circle, and the number of the original measuring points is 4, including A1, A2, A3, and A4. When the number of the measuring points is adjusted, using the parameters adjusting window, to 6, for example, six new measuring points is generated including PT1, PT2, PT3, PT4, PT5, and PT6, which are distributed equally around the circle.

In step S15, the second computation module 105 computes corrected coordinates of the new measuring points according to a predetermined deviation or a deviation adjusted using the parameters adjusting window. In one embodiment, when the vector of the fitted measuring element is (a, b, c), the coordinate of a new measuring point is (x2, y2, z2), the deviation is D, then, the corrected coordinate of this new measuring point is (x2−a*D, y2−b*D, z2−c*D).

In step S16, the second drawing module 106 draws the new measuring points on the fitted measuring element according to the corrected coordinates, and deletes the original measuring points from the fitted measuring element.

In step S17, the processing module 107 determines a measuring sequence of the new measuring points, generates a measuring program according to the measuring sequence, and outputs the measuring program on the display device 11. One example of the measuring program is shown as follows;

### C0001 PtMeas (IJK(−0.00000, −0.0000, 1.00000), X(0,00000), Y(0.00000), Z(0.0000))

### C0002 GoTo(X(4.07433837),Y(2.51326082),Z(0.908476770))

### C0003 GoTo(X(4.449771432),Y(2.76850634),Z(0.908476770))

### C0004 GoTo(X(4.19719867),Y(2.23973502),Z(0.908476770))

### C0005 GoTo(X(4.88152855),Y(−2.97137282),Z(0.908476770))

### C0006 GoTo(X(8.90914029),Y(3.69028674),Z(0.908476770))

### C0007 GoTo(X(10.60660172),Y(−4039339828),Z(0.908476770)).

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method of graphic processing for measuring elements of an object, the method being performed by execution of computerized codes by a processor of a measurement device, the method comprising:
acquiring original measuring points which are selected on the object, and obtaining a measuring element which is fitted using the original measuring points;
computing vectors of the original measuring points based on the measuring element;
drawing the measuring element and the original measuring points based on the vectors;
generating new measuring points according to a number of the original measuring points;
computing corrected coordinates of the new measuring points according to a predetermined deviation;
drawing the new measuring points on the measuring element according to the corrected coordinates, and deleting the original measuring points from the measuring element; and
determining a measuring sequence of the new measuring points, generating a measuring program according to the measuring sequence, and outputting the measuring program on a display device of the measurement device.

2. The method according to claim 1, wherein the measuring element is one type of a line, a plane, a circle, a cylinders, and a sphere.

3. The method according to claim 2, before obtaining a measuring element, the method further comprising:
fitting each type of the measuring element using the original measuring points;
computing a fitting deviation of each of the fitted measuring elements; and
obtaining the measuring element which has the least fitting deviation.

4. The method according to claim 1, wherein:
the vectors are vertical to the measuring element upon condition that the measuring element is a line;
the vectors are pointed to the center of the measuring element upon condition that the measuring element is a circle;
the vectors are vertical to the measuring element upon condition that the measuring element is a plane;
the vectors are vertical to the center axis of the measuring element upon condition that the measuring element is a cylinder; and
the vectors are pointed to the center of the measuring element upon condition that the measuring element is a sphere.

5. The method according to claim 1, before generating new measuring points, the method further comprising:
generating a parameter adjusting window, and displaying the parameter adjusting window on the display device, wherein the parameter adjusting window comprises a type box for selecting a measuring element, a number box for adjusting a number of the new measuring points of the selected measuring element, and a deviation box for adjusting the deviation of the selected measuring element.

6. The method according to claim 1, wherein the new measuring points are distributed equally on the measuring element.

7. A measurement device, comprising:
a non-transitory storage device;
at least one processing device; and
one or more modules that are stored in the non-transitory storage device and executed by the at least one processing device, the one or more modules comprising instructions to:
acquire original measuring points which are sampled on an object, and obtain a measuring element which is fitted using the original measuring points;
compute vectors of the original measuring points based on the measuring element;
draw the measuring element and the original measuring points based on the vectors;
generate new measuring points according to a number of the original measuring points;
compute corrected coordinates of the new measuring points according to a predetermined deviation;
draw the new measuring points on the measuring element according the corrected coordinates, and delete the original measuring points from the measuring element; and
determine a measuring sequence of the new measuring points, generate a measuring program according to the measuring sequence, and output the measuring program on a display device of the measurement device.

8. The measurement device according to claim 7, wherein the measuring element is one type of a line, a plane, a circle, a cylinders, and a sphere.

9. The measurement device according to claim 8, wherein the one or more modules further comprises instructions to:
fit each type of the measuring element using the original measuring points;
compute a fitting deviation of each of the fitted measuring elements; and
obtain the measuring element which has the least fitting deviation.

10. The measurement device according to claim 7, wherein:
the vectors are vertical to the measuring element upon condition that the measuring element is a line;
the vectors are pointed to the center of the measuring element upon condition that the measuring element is a circle;
the vectors are vertical to the measuring element upon condition that the measuring element is a plane;
the vectors are vertical to the center axis of the measuring element upon condition that the measuring element is a cylinder; and
the vectors are pointed to the center of the measuring element upon condition that the measuring element is a sphere.

11. The measurement device according to claim 7, wherein the one or more modules further comprises instructions to:
generate a parameter adjusting window, and display the parameter adjusting window on the display device, wherein the parameter adjusting window comprises a type box for selecting a measuring element, a number box for adjusting a number of the new measuring points of the selected measuring element, and a deviation box for adjusting the deviation of the selected measuring element.

12. The measurement device according to claim 7, wherein the new measuring points are distributed equally on the measuring element.

13. A non-transitory storage medium having stored thereon instructions that, when executed by a processor of an measurement device, causes the processor to perform a method of graphic processing for measuring elements of an object, wherein the method comprises:
acquiring original measuring points which are sampled on the object, and obtaining a measuring element which is fitted using the original measuring points;
computing vectors of the original measuring points based on the measuring element;
drawing the measuring element and the original measuring points based on the vectors;
generating new measuring points according to a number of the original measuring points;
computing corrected coordinates of the new measuring points according to a predetermined deviation;
drawing the new measuring points on the measuring element according the corrected coordinates, and deleting the original measuring points from the measuring element; and
determining a measuring sequence of the new measuring points, generating a measuring program according to the measuring sequence, and outputting the measuring program on a display device of the measurement device.

14. The non-transitory storage medium according to claim 13, wherein the measuring element is one type of a line, a plane, a circle, a cylinders, and a sphere.

15. The non-transitory storage medium according to claim 14, before obtaining a measuring element, wherein the method further comprises:
fitting each type of the measuring element using the original measuring points;
computing a fitting deviation of each of the fitted measuring elements; and
obtaining the measuring element which has the least fitting deviation.

16. The non-transitory storage medium according to claim 13, wherein:
the vectors are vertical to the measuring element upon condition that the measuring element is a line;
the vectors are pointed to the center of the measuring element upon condition that the measuring element is a circle;
the vectors are vertical to the measuring element upon condition that the measuring element is a plane;
the vectors are vertical to the center axis of the measuring element upon condition that the measuring element is a cylinder; and
the vectors are pointed to the center of the measuring element upon condition that the measuring element is a sphere.

17. The non-transitory storage medium according to claim 13, before generating new measuring points, wherein the method further comprises:
generating a parameter adjusting window, and displaying the parameter adjusting window on the display device, wherein the parameter adjusting window comprises a type box to select a measuring element, a number box to adjust a number of the new measuring points of the selected measuring element, and a deviation box to adjust the deviation of the selected measuring element.

18. The non-transitory storage medium according to claim 13, wherein the new measuring points are distributed equally on the measuring element.
